(19) United States
(12) Patent Application Publication
(10) Pub. No.: US 2025/0229225 A1
(43) Pub. Date: Jul. 17, 2025

(54) System and Method for CO2 Capture Utilizing Ash from Coal Fired Furnaces

(71) Applicant: CHRISTOPHER Lynn ABEYTA, Farmington, NM (US)

(72) Inventor: CHRISTOPHER Lynn ABEYTA, Farmington, NM (US)

(21) Appl. No.: 18/412,534

(22) Filed: Jan. 14, 2024

(51) Int. Cl. B01D 53/83; B01D 53/62

(52) U.S. Cl. CPC B01D 53/83; B01D 53/62; B01D 2257/504; B01D 2258/0283

(57) ABSTRACT

System and methods for capturing carbon dioxide (CO2) and permanently sequestering through mineral carbonization from coal fired furnace ash.

### FIELD OF INVENTION

The subject of this disclosure may relate generally to systems, devices, and methods for capturing or utilizing carbon dioxide (CO2) and permanently sequestering through mineral carbonization from ash produced by coal fired utility furnaces.

### BACKGROUND OF THE INVENTION

There is a growing concern, now international in scope, over the effects of global warming, caused significantly by industrial emissions of greenhouse gases (e.g., Carbon Dioxide [CO2], Methane [Ch4], etc.) into earth's troposphere. Essentially, these gases, when concentrated in the atmosphere: absorb radiant energy from the sun; emit this energy in all directions, including to the earth; and block radiant energy emitted to the earth from escaping back into space, thus causing what is referred to as the greenhouse effect, which causes the earth's average global surface temperature, also referred to as average earth temperature to increase over time (i.e., global warming).

According to the U.S. Department of Energy, there is no greater challenge facing our nation and our planet than the current climate crisis and rebalancing of Earth's carbon cycle.

According to the United Nations Climate Action, the science shows clearly that in order to avert the worst impacts of climate change and preserve a livable planet, global temperature increase needs to be limited to 1.5° C. above pre-industrial levels. Currently, the Earth is already about 1.1° C. warmer than it was in the late 1800s, and emissions continue to rise. To keep global warming to no more than 1.5° C.—as called for in the Paris Agreement—emissions need to be reduced by 45% by 2030 and reach net zero by 2050. Net zero refers to a state in which the greenhouse gases going into the atmosphere are balanced by removal out of the atmosphere.

According to NASA, the effects of human-caused global warming are happening now, and without intervention are irreversible for people alive today. These effects will worsen as long as humans add greenhouse gases to the atmosphere. We already see the effects scientists have predicted, such as the loss of sea ice, melting glaciers and ice sheets, sea level rise, and more intense heat waves, increased frequency of intense, destructive storms (e.g., hurricanes, tornadoes, and heavy rainfall) and relocation or extinction of many wildlife species.

CO2 capture technologies have become a major area of study to reduce CO2 emissions from fossil fuel consumption around the world.

It is in the above-explained context that this patent application is being submitted to the Patent Office, with the intent of offering a solution for CO2 capture and permanent sequestration from a coal fired furnace or permanently sequestering CO2 from other point or direct air captured sources through mineral carbonization from coal ash is presented herein.

### SUMMARY OF THE INVENTION

A system of the invention is disclosed herein. In various embodiments, capturing CO2 from the flue gas of a coal fired utility furnace by mineral carbonization of the alkaline earth metals found in the fly ash produced from burning coal. The required reaction temperature and the addition of water for the earth metals to change to their hydroxide form are provided by the special designed modified soot blowers. The retrofitted soot blowers extract and deliver the heated flue gas containing the CO2 gas and the steam to the fluidized bed mixers. After the CO2 is captured by mineralization in the fluidized mixer, the de-carbonized flue gas is returned back into the flue gas duct.

A system of the invention is disclosed herein. In various embodiments, sequestering CO2 captured from point or direct air sources by mineral carbonization of the alkaline earth metals found in both the fly and bottom ash stored in permanent underground ash impoundment storage locations.

### BRIEF DESCRIPTION OF THE DRAWINGS

These and other features, aspects, and advantages will become better understood with reference to the following descriptions of the accompanying drawings where:

FIG. 1 is an exemplary embodiment of a retrofitted soot blower for extracting flue gas at the required mineral carbonization temperatures and for the injection of water into the extracted flue gas in the fluidized bed reactor.

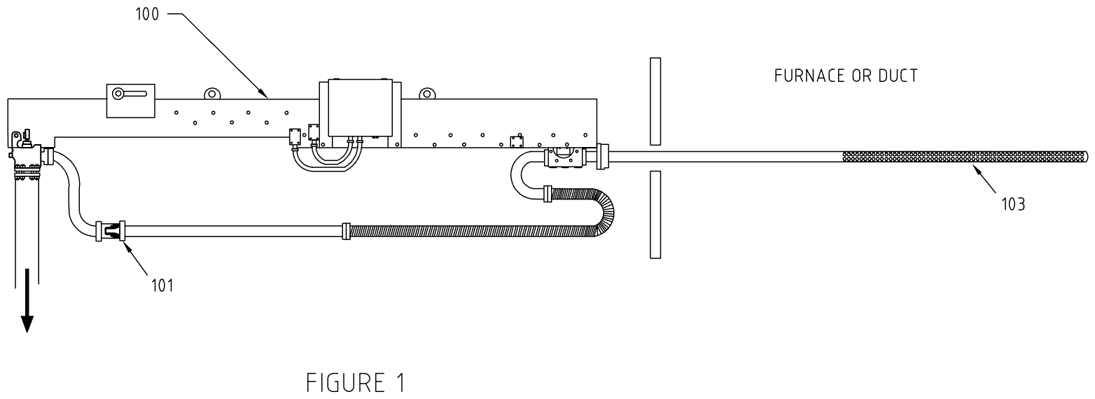

FIG. 2 illustrates a system, method and devices for CO2 capture and sequestration from mineral carbonization by alkaline earth metals in the fly ash from a coal fired utility furnace.

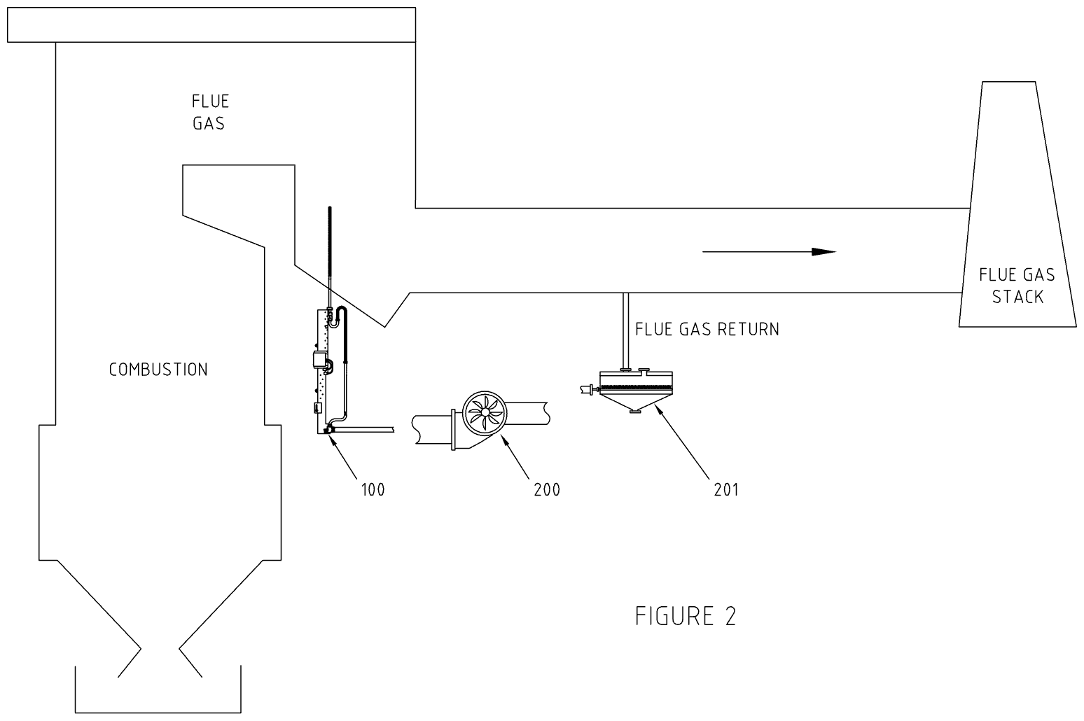

FIG. 3 illustrates a system, method and devices for sequestration of point or direct air captured CO2 by mineral carbonization of the alkaline earth metals found in stored ash impoundments or landfills.

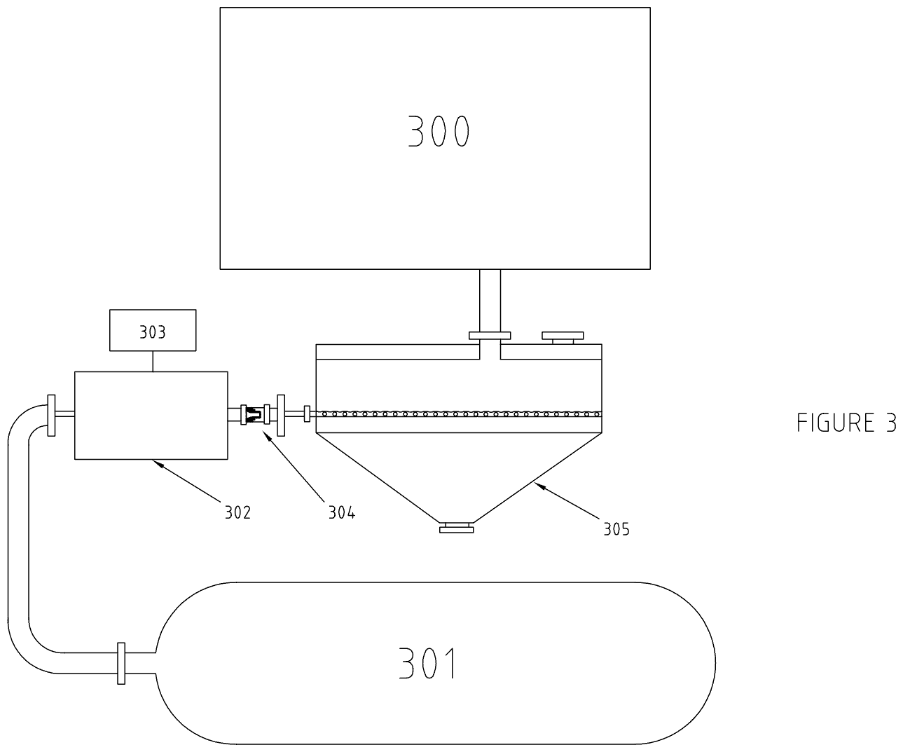

### DETAILED DESCRIPTION

In various embodiments, the method of the system and devices can comprise; a portion of the flue gas being diverted (103) at a specific extracted temperature by device (100) and water (steam) is injected into the flue gas (101). The extracted flue gas containing the CO2 is pneumatically conveyed by a high temperature centrifugal fan (200) to the fluidized bed mixer (201) where the fly ash is contained. As the flue gas passes through the ash in the fluidized bed mixer, the CO2 is captured through mineral carbonization and sequestered in the ash. The decarbonized diverted flue gas is then recombined and moved up the flue gas stack.

In various embodiments, the method of the system and devices can comprise; a coal ash impoundment or landfill (300) for sequestering the CO2 captured from point or direct air sources for mineral carbonization by the alkaline earth metals found in the ash. The ash is gravity fed or pneumatically conveyed to a fluidized bed reactor (305). The CO2 captured from point or direct air is received from a pressurized storage vessel (301). The CO2 gas is heated from a renewable energy source (303) in the reaction chamber (302). Water (steam is injected into the CO2 gas (304) prior to entering the fluidized bed mixer (305).

Based on the testing results of the characterization and adsorption experiments performed for coal fly ash, several factors affect the kinetics and adsorption capacity of CO2 based on the geographical location where the coal was formed and the type of post treatment the utility implemented for addressing the mitigation of the greenhouse gasses emitted.

As seen in the experimental analysis for coal fired fly ash, the particle size of the fly ash affects the surface area, and therefore increase the adsorption capacity and the kinetics of the reaction. In addition, if the fly ash is fluidized into the flue gas, a smaller particle size would lower the crucial flow rate that would be needed to keep the fly ash suspended in the flue gas stream.

If the alkaline earth metals (e.g.; CaO, MgO, FeO etc.) concentration are higher from different sources, the kinetic and adsorption capacity also increased from the samples tested.

It was also found that the injection of steam (water) into the extracted flue gas increases the CO2 adsorption capacity as well as the kinetics. The water converts the alkaline earth metals to its hydroxide form. Example, CAO was converted to calcium hydroxide making it more active to carbon capture not only at lower temperatures but also with faster kinetics.

These detailed descriptions of the present invention are not intended as a limitation on the use or applicability of the invention. It should be appreciated that the particular implementations shown and described herein are illustrative of various embodiments including its best mode and are not intended to limit the scope of the present disclosure in any way. Furthermore, the connecting lines shown in the various figures contained herein are intended to represent exemplary functional relationships. It should be noted that many alternative or additional functional relationships or physical connections may be present in a practical system.

While the principles of the disclosure have been shown in various embodiments, many modifications of structure, arrangements, proportions, devices, materials and components, used in practice, which are particularly adapted for a specific environment and operating requirements without departing from the principles and scope of this disclosure. These and other changes or modifications are intended to be included within the scope of the present disclosure and may be expressed in the following claims.

We claim:

1. A system and method of retrofitting a soot blower to extract flue gas in a utility furnace at specific temperatures for CO2 capture and sequestration by mineral carbonization.

2. The method of claim 1, wherein the suction produced to extract the CO2 contained flue gas is provided by a high temperature centrifugal fan to provide the required flow to the fluidized bed mixer.

3. The method of claim 1, wherein the flue gas diverted from the utility furnace is screened from particulate matter by a perforated lance tube.

4. The method of claim 1, wherein the soot blow feed tube is flexible.

5. The method of claim 1, wherein the addition of water or compound to the extracted flue gas for improving the adsorption and kinetics of the extracted CO2.

6. The method of claim 1, wherein the extracted flue gas after the CO2 is desorbed from the flue gas is returned back to the flue gas duct.

7. A system and method of capturing CO2 utilizing ash by mineral carbonization produced from a coal fired utility furnace.

8. The method of claim 7, wherein the CO2 source is from flue gas extracted from a coal fired utility furnace.

9. The method of claim 7, wherein the CO2 source is from flue gas extracted from a natural gas fired utility furnace.

10. The method of claim 7, wherein the CO2 source is from point or direct air captured CO2.

11. The method of claim 7, wherein the ash utilized for CO2 capture by mineral carbonization is sourced from the production of ash from an operating coal fired utility furnace.

12. The method of claim 7, wherein the ash used for CO2 capture by mineral carbonization is sourced from stored ash impoundments or landfills.

13. The method of claim 7, wherein the mixing of the CO2 and ash is accomplished by a fluidized mixer.
